(19) United States
(12) Patent Application Publication
(10) Pub. No.: US 2002/0024978 A1
(43) Pub. Date: Feb. 28, 2002

(54) Laser device and seed light optimization method

(76) Inventors: Yoshihiko Inagaki, Oyama-shi (JP); Kazuaki Sajiki, Hiratsuka-shi (JP); Takashi Nire, Hiratsuka-shi (JP)

Correspondence Address: VARNDELL & VARNDELL, PLLC, 106-A South Columbus Street, Alexandria, VA, 22314, US

(21) Appl. No.: 09/931,035

(22) Filed: Aug. 17, 2001

(30) Foreign Application Priority Data
Aug. 28, 2000 (JP) 257520/2000
Jun. 14, 2001 (JP) 180418/2001

(51) Int. Cl. H01S 3/10; H01S 3/091; H01S 3/092

(52) U.S. Cl. 372/20; 372/70

(57) ABSTRACT

When it is determined that a pulse width of high harmonic light Lb to jitter of discharge light Ld is not appropriate as a result of comparison between a waveform of the discharge light Ld and that of the high harmonic light Lb, a main controller judges that the jitter of the discharge light Ld in a gas laser device is large, and controls to move a translating stage to extend a cavity length so to increase a pulse width of fundamental harmonic light La which is laser-oscillated by an oscillator. When the main controller determines that a light intensity of the high harmonic light Lb has a value smaller than a predetermined value and is not normal, it controls to move the translating stage to shorten the cavity length so to enhance the light intensity of seed light La to be laser-oscillated by the oscillator. Thus, the light intensity and pulse width of the seed light at injection locking are optimized.

### BACKGROUND OF THE INVENTION

1. Field of the Invention

The present invention relates to a laser device for oscillation of a pulsed laser and an optimization method of seed light which is subjected to a pulsed laser oscillation by an injection-locked laser device.

2. Description of the Related Art

Conventional laser devices include an injection-locked laser device which is comprised of an oscillating stage and an amplifying stage. For example, an injection-locked laser device is described in Japanese Patent Application Laid-Open No. 1-302888.

The laser device described in the above publication has a synchronizing laser oscillation system (corresponding to the aforesaid oscillating stage) having alexandrite as a laser medium and an excimer laser oscillation system (corresponding to the aforesaid amplifying stage). The synchronizing laser oscillation system is configured to perform injection locking of laser light, which has laser oscillation time t2 longer than laser oscillation time t1 of the excimer laser oscillation system and the same wavelength, to the excimer laser oscillation system.

The above conventional laser device performs laser oscillation of the laser light having the laser oscillation time t1 (namely, t1<t2) by the excimer laser oscillation system before a lapse of the laser oscillation time t2 during which the laser light is laser-oscillated by the synchronizing laser oscillation system. In other words, the laser light (namely, seed light) which is laser-oscillated by the synchronizing laser oscillation system is long-pulsed by the injection locking, to reduce the influence of jitter in an electrical discharge signal system.

In the injection-locked laser device, even if the timing of laser oscillation in the oscillating stage is synchronized with the timing of an electrical discharge in the amplifying stage to perform injection locking in the amplifying stage, the injection locking fails in the amplifying stage resulting in a free running state when the laser light from the oscillating stage has not reached a predetermined light intensity.

However, the aforesaid conventional laser device makes the laser oscillation time t2 in the synchronizing laser oscillation system (oscillating stage) longer than the laser oscillation time t1 in the excimer laser oscillation system (amplifying stage) to make the seed light (laser light) have long pulsation so to reduce an influence of jitter in the discharge signal system. But, there is no description or indication of adjustment of the light intensity of the long-pulsated seed light.

Because the aforesaid conventional laser device does not deal with the light intensity of the seed light from the synchronizing laser oscillation system (oscillating stage), it might be possible that the seed light which has not reached the predetermined light intensity is injected into the amplifying stage. Therefore, the injection locking is not made in the amplifying stage, possibly resulting in a free running state.

Accordingly, laser light having a desired light intensity cannot be obtained from the amplifying stage in the free running state.

Under the circumstances described above, it is a first object of the invention to provide a laser device which can optimize the light intensity and pulse width of laser light which is laser-oscillated.

It is a second object of the invention to provide a laser device which can optimize the light intensity and pulse width of seed light at injection locking.

It is a third object of the invention to provide a seed light optimization method, which can optimize the light intensity and pulse width of seed light at injection locking.

### SUMMARY OF THE INVENTION

To achieve the first object, a first aspect of the invention is a laser device which has an optical resonator, a laser medium disposed in the optical resonator and a pumping source for pumping the laser medium, and which resonates in the optical resonator the pumped light from the laser medium pumped by the pumping source to perform laser oscillation of laser light, wherein the optical resonator is disposed to have an adjustable resonator length and provided with detecting means for detecting the laser-oscillated laser light, and adjusting means for adjusting the resonator length of the optical resonator on the basis of a result detected by the detecting means.

The first aspect of the invention will be described with reference to FIG. 1 and FIG. 3.

As shown in FIG. 1, laser device 1 has the optical resonator comprised of rear mirror M1 mounted on movably disposed translating stage 15 and front mirror M2.

When laser light (pumping light) is oscillated from pump laser 13 with predetermined timing, the pumping light is irradiated to titanium sapphire 11. The titanium sapphire 11 is pumped by the irradiated pumping light, and light (pumped light) is emitted from the titanium sapphire 11. The pumped light travels to resonate between the rear mirror M1 and the front mirror M2 (in the optical resonator), so that only light selected by wavelength selection element 12 is emitted as laser light La from the front mirror M2.

The laser light emitted from the front mirror M2 is partly reflected by beam splitter B•S and detected by power monitor 18 (the aforesaid detecting means).

The power monitor 18 sends a detection signal corresponding to the light intensity of the laser light La resulting from the detection to resonator length adjusting controller 19 (the aforesaid adjusting means). The resonator length adjusting controller 19 rotates a drive motor in a predetermined direction on the basis of the detection signal so as to expand or contract a cavity length, thereby controlling to move the translating stage 15.

FIG. 3 shows examples of oscillation waveforms of the laser light emitted from the front mirror M2 when the laser oscillation is performed with respective cavity lengths (optical resonator lengths) when the position of the rear mirror M1 is changed.

FIG. 3 shows the oscillation waveforms of the laser light laser-oscillated with the cavity length set long in order of oscillation waveform P1, oscillation waveform P2 and oscillation waveform P3. It is apparent from the respective oscillation waveforms that the oscillation waveform has a high light intensity and a short pulse width when the cavity length is short as compared with the oscillation waveform when the cavity length is long.

In other words, the light intensity and pulse width of the laser light can be changed by changing the position of the rear mirror M1 to change the cavity length.

As described above, the light intensity and pulse width of the laser light laser-oscillated can be optimized by adjusting the resonator length according to the first aspect of the invention.

To achieve the second object, the laser device according to the second aspect of the invention comprises: an oscillating stage which has an optical resonator disposed to have an adjustable resonator length and outputs light resonated by the optical resonator as seed light; an amplifying stage which has a laser medium and a pumping source, and outputs pulse light by stimulated emission of the seed light to amplify when pumping of the laser medium by the pumping source is synchronized with injection of the seed light output from the oscillating stage; and detecting means for detecting the pulse light, wherein the resonator length of the optical resonator is adjusted on the basis of a result detected by the detecting means.

The second aspect of the invention will be described with reference to FIG. 4.

In oscillator 10 as the oscillating stage, the optical resonator is comprised of the rear mirror M1 mounted on the movably disposed translating stage 15 and the front mirror M2.

Main controller 30 obtains a plurality of signals indicating waveforms of electrical discharge light Ld from pulse monitor 26 and a plurality of signals indicating waveforms of high harmonic light Lb from pulse monitor 46 for different laser oscillations while laser oscillation is repeatedly performed, and also obtains a plurality of signals indicating output (light intensity) of high harmonic light Lb from power monitor 47 and a plurality of signals indicating output (light intensity) of output laser light Lc from power monitor 48 for different laser oscillations.

Then, the main controller 30 refers to data on pulse waveforms stored in an unshown storage to compare a waveform of the electrical discharge light Ld and a waveform of the high harmonic light Lb. When it is determined that a pulse width of the high harmonic light Lb to the jitter of the electrical discharge light Ld is not appropriate, it is judged that the jitter (time error) of the electrical discharge light Ld in gas laser device 20 as the amplifying stage is large, the drive motor is rotated in a predetermined direction to control the movement of the translating stage 15 to expand the cavity length in order to extend the pulse width of the laser light (seed light) oscillated by the oscillator 10.

Besides, when the main controller 30 judges that the pulse width of the high harmonic light Lb to the jitter of the electrical discharge light Ld is appropriate, it refers to data on the light intensity stored in the storage section (not shown) to determine whether the light intensity of the high harmonic light Lb has a value equal to or higher than predetermined threshold value Ith1 (whether the light intensity is normal or not).

When the main controller 30 judges that the light intensity of the high harmonic light Lb is lower than the threshold value Ith1 and not normal, it controls to move the translating stage 15 by rotating the drive motor in a predetermined direction to shorten the cavity length in order to enhance the light intensity of the laser light (seed light), namely fundamental harmonic light La, output from the oscillator 10.

Here, as to the relation among the cavity length, the output (light intensity) of the high harmonic light Lb output from wavelength conversion section 45 and the pulse width of the high harmonic light Lb, the cavity length and the pulse width of the high harmonic light Lb are proportional to each other as shown in FIG. 6, and the cavity length and the output (light intensity) of the high harmonic light Lb are inversely proportional to each other.

Therefore, the light intensity and pulse width of the seed light (corresponding to the high harmonic light) laser-oscillated by the oscillator 10 can be adjusted by changing the cavity length between the rear mirror M1 and the front mirror M2 by controlling to move the translating stage 15 on which the rear mirror M1 is mounted.

As described above, the light intensity and pulse width of the seed light at the injection locking can be optimized by adjusting the resonator length according to the second aspect of the invention.

Besides, to achieve the third object, a seed light optimizing method according to the third aspect of the invention comprises: an oscillating step for outputting light resonated by an optical resonator, which is disposed to have an adjustable resonator length, as seed light; an amplifying step for outputting pulse light by stimulated emission of the seed light to amplify when pumping of a laser medium by a pumping source for pumping the laser medium is synchronized with injection of the seed light output by the oscillating step; a detecting step for detecting the pulse light; and an adjusting step for adjusting a resonator length of the optical resonator on the basis of a result detected by the detecting step.

The third aspect of the invention will be described with reference to FIG. 7.

“Detecting Step”

The power monitor 47 detects output (light intensity) of light (leakage light) passed through reflection mirror 43, which is part of high harmonic light Lb entering from wavelength conversion section 45 into the reflection mirror 43, and the power monitor 48 detects a light intensity of the laser light reflected from the beam splitter B•S and outputs each detected result (light intensity) to the main controller 30.

The pulse monitor 46 detects light (leakage light) passed through reflection mirror 44, which is part of the high harmonic light Lb entering into the reflection mirror 44, and the pulse monitor 26 detects luminescence (electrical discharge light) Ld resulting from the electrical discharge caused between electrical discharge electrodes 22 and sends the respective detected results (signals indicating the pulse) to the main controller 30.

Meanwhile, the controller 30 adjusts the light intensity and pulse width of the laser light on the basis of the detected results from the aforesaid monitors.

(1) Adjustment of Pulse Width of Seed Light

“Adjusting Step”

The main controller 30 refers to data on pulse waveforms stored in the unshown storage section to compare a waveform of the electrical discharge light Ld and that of the high harmonic light Lb (step S102) and determines whether the pulse width of the high harmonic light Lb to the jitter of the electrical discharge light Ld is appropriate or not (step S103).

When the main controller 30 determines in step S103 that the pulse width of the high harmonic light Lb to the jitter of the electrical discharge light Ld is not appropriate, it judges that the jitter (time error) of the electrical discharge light Ld in the gas laser device 20 is large (step S104).

In order to increase the pulse width of the laser fight (seed light) oscillated by the oscillator 10, the translating stage 15 is controlled to move by rotating the drive motor in a predetermined direction to expand the cavity length (step S105).

(2) Adjustment of Light Intensity of Seed Light

“Adjusting Step”

The main controller 30 having determined in the aforesaid step S103 that the pulse width of the high harmonic light Lb to the jitter of the electrical discharge light Ld is appropriate refers to data on the light intensity stored in the aforesaid storage section to determine whether the light intensity of the high harmonic light Lb has a value equal to or higher than the predetermined threshold value Ith1 (whether the light intensity is normal or not) (step S106).

When the main controller 30 determines that the light intensity of the high harmonic light Lb has a value smaller than the aforesaid threshold value Ith1 and is not normal, it judges that the light intensity of the output laser light Lc is also not normal because injection locking is not applied, and to enhance the light intensity of the laser light (seed light), namely fundamental harmonic light La, which is output from the oscillator 10, the translating stage 15 is controlled to move by rotating the drive motor in a predetermined direction so to shorten the cavity length (step S107).

As described above, according to the third aspect of the invention, the light intensity and pulse width of the seed light at the injection locking can be optimized by adjusting the oscillator length.

### BRIEF DESCRIPTION OF THE DRAWINGS

FIG. 1 is a structure diagram showing a structure of laser device 1 according to a first embodiment of the invention;

FIG. 2 is a diagram showing a relation between a relative distance in an optical resonator and a radius of 1/eˆ 2;

FIG. 3 is a diagram illustrating a relation between a cavity length and an oscillation waveform of an oscillator;

FIG. 4 is a structure diagram showing a structure of laser device 50 according to a second embodiment of the invention;

FIG. 5 is a structure diagram showing a structure of wavelength conversion section 45 of the laser device shown in FIG. 4;

FIG. 6 is a diagram showing a relation among a cavity length of the oscillator of the second embodiment, a pulse width of laser light to be laser-oscillated and a light intensity of the laser light;

FIG. 7 is a flow chart showing a procedure of adjusting a pulse width and light intensity of laser light to be laser-oscillated by the oscillator;

FIG. 8 is a flow chart showing a procedure of compensating discharge timing depending on a delay; and

FIG. 9 is a structure diagram showing a structure of the laser device according to a third embodiment of the invention.

### DETAILED DESCRIPTION OF THE PREFERRED EMBODIMENTS

Embodiments of the present invention will be described with reference to the accompanying drawings.

[First Embodiment]

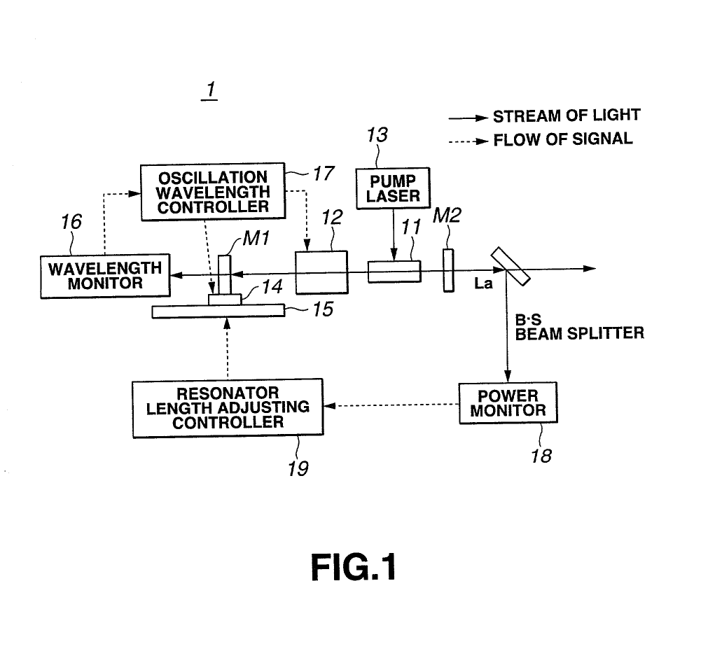

FIG. 1 is a structure diagram showing a structure of the laser device 1 according to one embodiment.

The laser device 1 has an optical resonator comprised of the rear mirror M1 which has high reflectivity (total reflection) with respect to an oscillation wavelength and the front mirror M2 which has partial reflectivity (e.g., a reflectance of 80%) with respect to the oscillation wavelength.

The front mirror M2 is stationarily disposed, while the rear mirror M1 is disposed to make the resonator length adjustable, namely it is movably disposed.

The optical resonator has the titanium sapphire (Ti³⁺:Al₂O₃) crystal (hereinafter called titanium sapphire) 11 as a laser medium and the wavelength selection element 12 for selecting an oscillation wavelength therein.

The wavelength selection element 12 is an optical element such as a prism, a grating or an etalon.

Laser light (pumping light) is irradiated from the pump laser 13 as a pumping source for pumping the laser medium to the titanium sapphire 11. Here, an Nd:YLF laser is used as the pump laser 13.

The rear mirror M1 is held by mirror holder 14 which adjusts an oscillation wavelength, and the mirror holder 14 is mounted on the translating stage 15 which adjusts a position of the rear mirror M1.

The translating stage 15 is moved to expand or contract an optical path length, namely a cavity length, between the rear mirror M1 and the front mirror M2 as the drive motor rotates in a predetermined direction.

Wavelength monitor 16 is comprised of a line sensor having a plurality of photoreceiving channels and sends information indicating the channel number of a channel which has detected light having a maximum intensity to oscillation wavelength controller 17.

An incident position to the line sensor is variable depending on a wavelength, so that the wavelength of light can be detected according to a light detection position (channel number) of the line sensor. Thus, the wavelength of light (leakage light) having passed through the rear mirror M1 can be known.

The oscillation wavelength controller 17 controls the wavelength selection element 12 or the mirror holder 14 so to have a desired oscillation wavelength on the basis of the detected result (information indicating a channel number) received from the wavelength monitor 16.

The power monitor 18 detects output (light intensity) of the laser light reflected (divided) by the beam splitter B•S and sends the detected result (detection signal corresponding to the detected light intensity) to the resonator length adjusting controller 19.

The resonator length adjusting controller 19 controls to move the translating stage 15 to provide a predetermined light intensity on the basis of the detected result (detection signal corresponding to the detected light intensity) received from the power monitor 18.

When light travels between the rear mirror M1 and the front mirror M2 (in the optical resonator), it needs to have a light intensity to some extent at a position where the light starting to oscillate passes through the laser medium, so that two lenses (not shown in FIG. 1) are disposed with the titanium sapphire 11 therebetween to gather the light.

The operation of the laser device 1 configured as described above will be described.

When the laser light (pumping light) is oscillated by the pump laser 13 with predetermined timing, the pumping light is irradiated to the titanium sapphire 11.

The titanium sapphire 11 is pumped by the pumping light irradiated as described above, and light (pumped light) is emitted from the titanium sapphire 11.

The pumped light travels to resonate between the rear mirror M1 and the front mirror M2 (in the optical resonator), and only light selected by the wavelength selection element 12 is emitted as the laser light La from the front mirror M2.

Light (laser beam) resonating in the optical resonator (between the rear mirror M1 and the front mirror M2) partly passes through the rear mirror M1, and the penetrated light (leakage light) is detected by the wavelength monitor 16.

A detection signal corresponding to the detected wavelength is sent from the wavelength monitor 16 to the oscillation wavelength controller 17.

The oscillation wavelength controller 17 controls to drive the wavelength selection element 12 or the mirror holder 14 on the basis of the detection signal from the wavelength monitor 16 to oscillate with a desired wavelength.

The laser light emitted from the front mirror M2 is partly reflected by the beam splitter B•S and detected by the power monitor 18.

The power monitor 18 sends a detection signal corresponding to the light intensity of the laser light La resulting from the detection to the resonator length adjusting controller 19. The resonator length adjusting controller 19 rotates the drive motor in a predetermined direction according to the detection signal to control the movement of the translating stage 15.

Thus, the rear mirror M1 is changed its present position so to expand or contract an optical distance (namely, cavity length) from the front mirror M2.

In a usual laser design, the cavity length is also a significant parameter, and a change in the parameter may not meet the oscillation condition. Therefore, the cavity length shall not be changed easily.

Regardless of the limitation of the laser design, the reason that the cavity length can be changed as described above in this embodiment will be explained.

In designing the cavity of the laser medium, namely the titanium sapphire 11, it is designed so that a change in beam diameter is small within a predetermined moving range of the rear mirror M1 which is moved to change the cavity length.

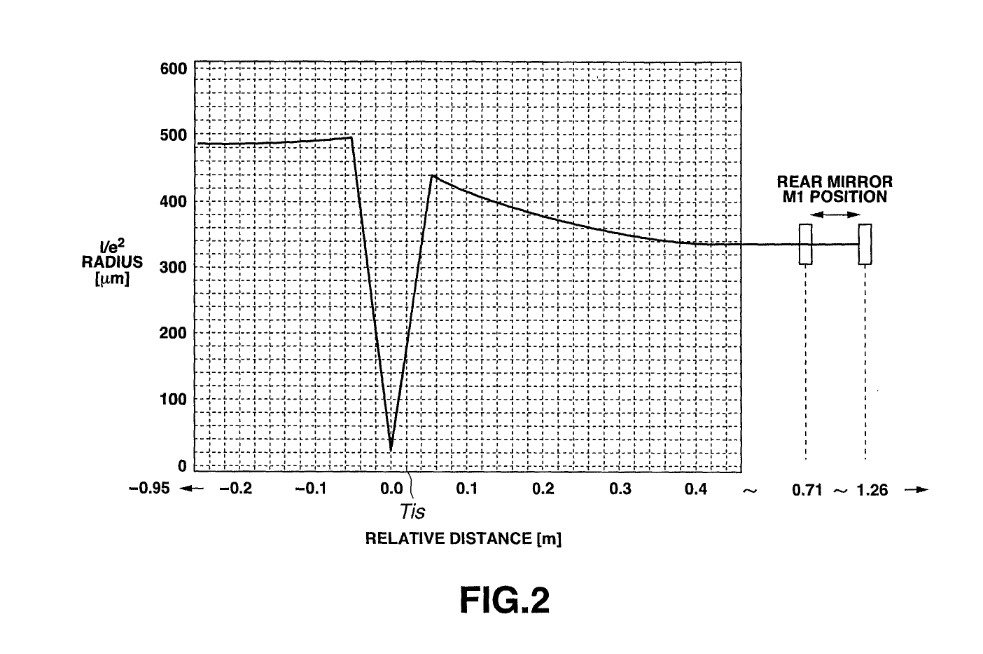

FIG. 2 shows a characteristic indicating a relation between a radius (hereinafter called 1/eˆ 2 radius) of a diameter (beam size) at a point to be 1/eˆ 2 (e is a base of natural logarithm) to an energy intensity of the beam center in a single transverse mode and a relative distance from a focal position.

According to the characteristic of FIG. 2, the light intensity is highest when the 1/eˆ 2 radius is minimum, and the light intensity lowers as the 1/eˆ 2 radius becomes large.

According to the characteristic, the beam size becomes small as the 1/eˆ 2 radius becomes small, and when the relative distance is for example 0.4 m or more, the 1/eˆ 2 radius is substantially constant (a change in beam diameter is small).

Even when the present position of the rear mirror M1 is changed (moved) in a range of relative distance that the change in beam diameter becomes small, for example in the relative distance of 0.7 to 1.3 m, a deviation of the cavity design due to a change in cavity length is small.

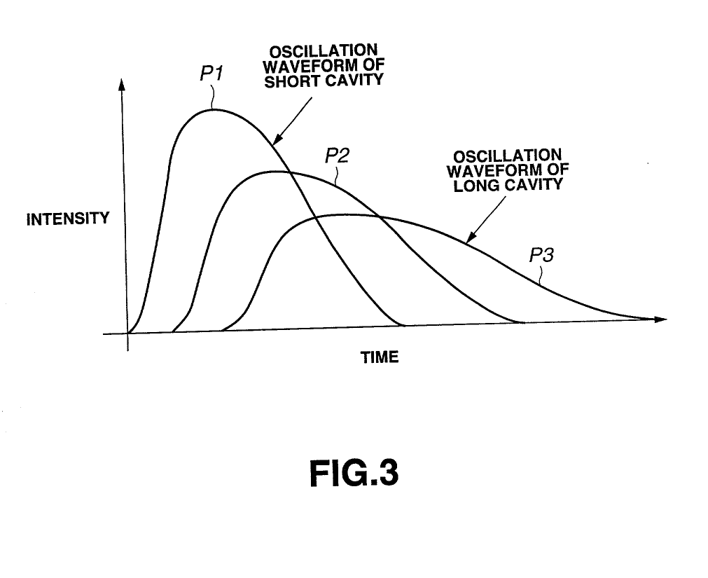

FIG. 3 shows oscillation waveform examples of laser light emitted from the front mirror M2 when laser oscillation is performed at each cavity length (optical resonator length) with the rear mirror M1 position changed.

FIG. 3 shows the oscillation waveforms of laser light laser-oscillated in a state that the cavity length is determined to be long in order of oscillation waveform P1, oscillation waveform P2 and oscillation waveform P3.

It is seen from the respective oscillation waveforms that the oscillation waveform with a short cavity length has a high light intensity and a short pulse width as compared with the oscillation waveform with a long cavity length.

In other words, the light intensity and pulse width of the laser light can be changed by changing the position of the rear mirror M1 to change the cavity length of the optical resonator in the oscillator 10.

The present invention is not limited to the aforesaid embodiment but can also be performed as described in the following (A) to (F) (as application examples).

(A) Specifically, the aforesaid embodiment changes the position of the rear mirror M1 but it is not a limited way. And, the following procedure may be taken.

(1) It may be designed so that the rear mirror M1 is stationary, and the position of the adjustable (movable) front mirror M2 is changed by the resonator length adjusting controller 19 to change the cavity length. At this time, the front mirror M2 is disposed at a position that the relative position is indicated by a negative value with “−” added in the characteristic shown in FIG. 2. Therefore, it is necessary to change the position of the front mirror M2 in a range of relative distance so that a change in beam diameter is reduced in the same way as the above embodiment.

Both the positions of the rear mirror M1 and the front mirror M2 may be changed to change the cavity length.

(B) In the above embodiment, the translating stage 15 on which the rear mirror M1 is mounted is moved to adjust the cavity length as a method of adjusting the optical resonator length (cavity length), but it is not limitative and the following procedure may be employed.

(2) Specifically, the rear mirror M1 may be placed on a linear guide, which is manually moved to change (adjust) the cavity length. In this case, the cavity length is manually adjusted because of its structure.

(3) To configure the optical resonator with the rear mirror M1 and the front mirror M2, it is also possible to have the mirrors at a plurality of different positions on the optical path, namely the optical axis, and mounts are disposed not to shield the resonating laser light. And, the rear mirror M1 is fitted to a particular mount among the plurality of mounts if necessary. In this case, the cavity length is manually adjusted because of the structure.

(4) A total reflection mirror for returning may be inserted between the rear mirror M1 and the front mirror M2. In this case, the cavity length is manually adjusted because of the structure.

(C) In the above embodiment, two unshown lenses which are disposed with the titanium sapphire 11 between them are used to have a characteristic as shown in FIG. 2 that only one light-gathering point is disposed, but it is not limitative and may be designed as follows.

(5) Specifically, the light-gathering point may be disposed in multiple numbers such as two or three. In this case, to adjust the pulse width and light intensity, it is necessary to change the position of the rear mirror M1 or the front mirror M2 in a section including a relative distance that the beam diameter change becomes small.

(D) In the aforesaid embodiment, titanium sapphire is used as a laser medium, but it is not limitative and the following may be used.

Specifically, Ti³⁺:BeAl₂O₄, alexandrite (Cr³⁺:BeAl₂O₃), Cr:LiSaF or neodymium glass may be used.

(E) In the aforesaid embodiment, the Nd:YLF laser is used as a pump laser, but it is not limitative, and the following may be used.

Specifically, an Nd:YAG laser, a laser diode (LD) or an ultraviolet lamp may be used.

(F) In the aforesaid embodiment, a combination of the Nd:YLF laser which is a pump laser and titanium sapphire which is a laser medium is used as the oscillator 10, but it is not limitative and the following may be used.

Specifically, a pigment laser (liquid laser), a parametric oscillation type laser, a fiber laser, a Raman transformation laser or the like may be used.

As described above, according to the embodiment, the cavity length (optical resonator length) is changed (expanded or contracted) by changing the position of the rear mirror M1 on the basis of the light intensity of the laser light La output from the front mirror M2, so that the light intensity and pulse width of the laser light La to be laser-oscillated can be changed.

[Second Embodiment]

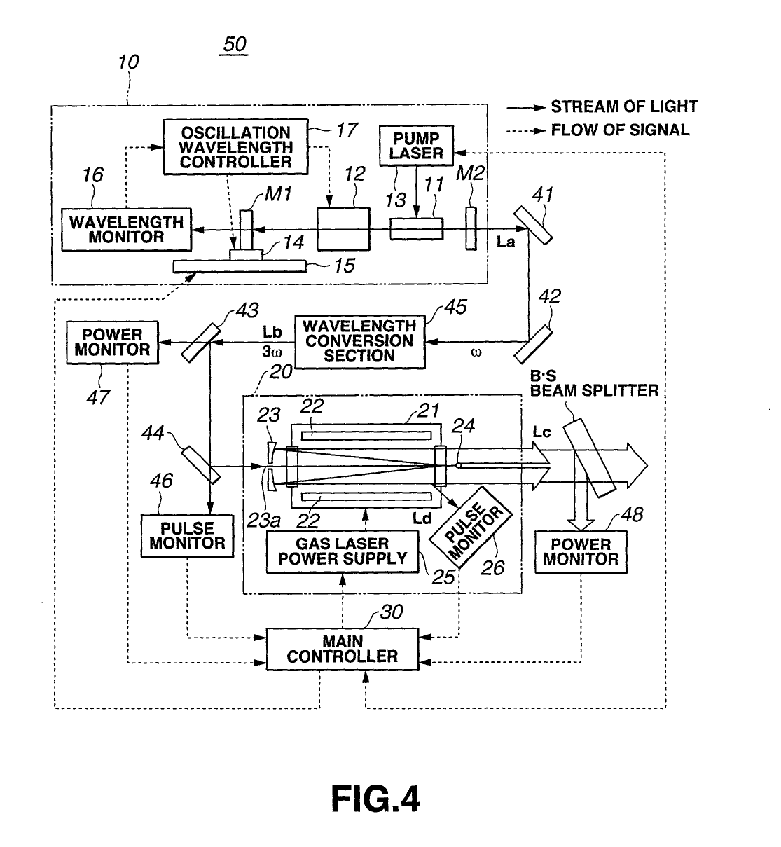

FIG. 4 is a structure diagram showing a structure of laser device 50 according to the second embodiment.

The laser device 50 is an injection-locked laser device and comprised of the oscillator 10 as an oscillating stage, the gas laser device 20 as an amplifying stage, the main controller 30, four reflection mirrors 41 to 44, the wavelength conversion section 45, the pulse monitor 46, the two power monitors 47, 48, and the beam splitter B•S.

The oscillator 10 shown in FIG. 4 has the same structure as that of the laser device 1 according to the first embodiment shown in FIG. 1 except that the beam splitter B•S, the power monitor 18 and the resonator length adjusting controller 19 are omitted. In FIG. 4, like reference numerals are used to indicate like components which have the same functions as those shown in FIG. 1.

The laser light (namely, seed light) La laser-oscillated from the oscillator 10 is reflected by the reflection mirrors 41, 42, entered into the wavelength conversion section 45, converted its wave length into the high harmonic light Lb, and entered into the gas laser device 20 through the reflection mirror 43 and the reflection mirror 44.

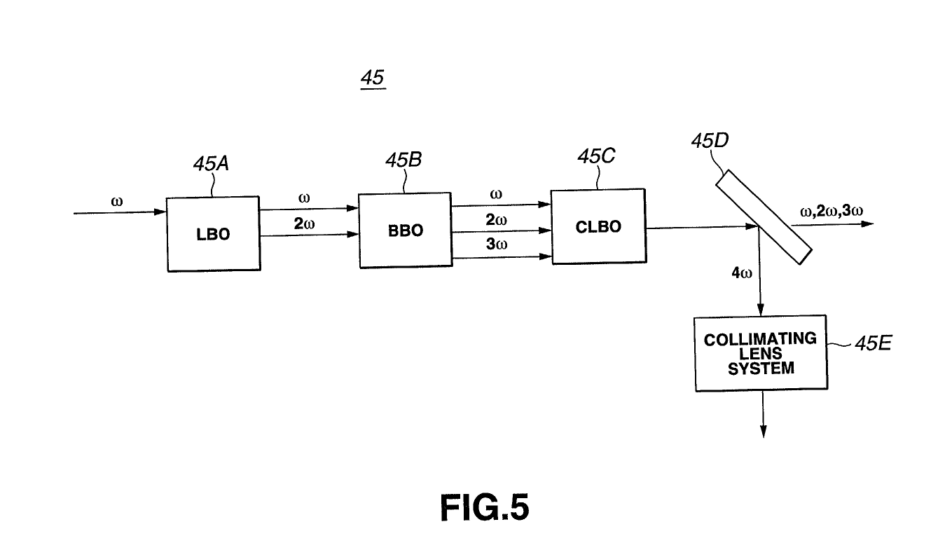

As shown in FIG. 5, the wavelength conversion section 45 is comprised of lithium triborate (LiB3O5=LBO) 45A, β-barium borate (β-BaB2O4=BBO) 45B, cesium lithium borate (CsLiB6O10=CLBO) 45C, 4ω mirror 45D, collimating lens system 45E, and unshown light-gathering lenses each disposed on the light incidence sides of the LBO 45A, BBO 45B and CLBO 45C.

The wavelength conversion section 45 performs wavelength conversion to change the laser light (seed light) La into high harmonic laser light Lb so to conform with a type of laser medium pumped by the gas laser device 20 as the amplifying stage, namely the wavelength of the laser light to be laser-oscillated.

The LBO 45A generates second high harmonic light (2ω) on the basis of the laser light La from the oscillator 10 and outputs the generated second high harmonic light and the remaining fundamental harmonic light.

The BBO 45B generates third high harmonic light (3ω) by sum frequency mixing of the fundamental harmonic light and the second high harmonic light and outputs the generated third high harmonic light, the remaining fundamental harmonic light and the second high harmonic light.

The CLBO 45C generates fourth high harmonic light (4ω) by sum frequency mixing of the fundamental harmonic light and the third high harmonic light and outputs the generated fourth high harmonic light, the remaining fundamental harmonic light and the second and third high harmonic lights.

The 4ω mirror 45D allows the fundamental harmonic light and the second and third high harmonic lights to pass through and reflects the fourth high harmonic light (4ω) only.

The collimating lens system 45E shapes the fourth high harmonic light, which was reflected by the 4ω mirror 45D, to parallel light.

The unshown light-gathering lenses gather the laser light into optical elements LBO45A, BBO45B and CLBO45C to facilitate the generation of high harmonic light by these optical elements.

The third high harmonic light can be obtained from the fundamental harmonic light by the nonlinear optical elements LBO45A and BBO45B but it is necessary to change the 4ω mirror 45D to a 3ω mirror which reflects the third high harmonic light (3ω) only.

In other words, the wavelength conversion section 45 can make the wavelength conversion depending on a type of laser by partly changing the optical elements. For example, for a krypton fluorine (KrF) excimer laser, laser light (fundamental harmonic light) La having a wavelength of 745 nm is changed its wavelength so to be laser light Lb which is the third high harmonic light having a wavelength of 248 nm.

For an argon fluorine (ArF) excimer laser, laser light (fundamental harmonic light) La having a wavelength of 772 nm is converted into laser light Lb which is the fourth high harmonic light having a wavelength of 193 nm.

Referring back to FIG. 4, the gas laser device 20 as the amplification stage is comprised of laser chamber 21 into which laser medium gas is charged, a pair of discharge electrodes 22 which are disposed to face each other in the laser chamber 21, concave total reflection mirror (rear mirror) 23 having laser inlet 23a, convex total reflection mirror 24, gas laser power supply 25 as a pumping source, and the pulse monitor 26 which detects luminescence Ld resulting from an electrical discharge and outputs the detected result to the controller 30.

Here, the gas laser device 20 performs laser oscillation of the krypton fluorine (KrF) excimer laser.

The gas laser device 20 has its optical resonator comprised of the concave total reflection mirror 23 and the convex total reflection mirror 24.

The pulse monitor 46 detects light (leakage light), which passes through the reflection mirror 44, in the laser light Lb which is high harmonic light entering into the reflection mirror 44, and outputs the detected result to the main controller 30.

The power monitor 47 detects output (light intensity) of light (leakage light), which passes through the reflection mirror 43, in the laser light Lb which is high harmonic light entering into the reflection mirror 43 and outputs the detected result to the main controller 30.

The power monitor 48 detects output (light intensity) of the laser light reflected by the beam splitter B•S in laser light Lc emitted from the gas laser device 20 and outputs the detected result to the main controller 30.

The main controller 30 is to control the oscillator 10 and the gas laser device 20 and, for example on the basis of the detected result from the pulse monitor 26, sends a trigger signal to the pump laser 13 and the gas laser power supply 25 and also controls the pulse width and light intensity of the laser light (seed light) La on the basis of the detected result from the respective monitors 26, 46, 47, 48.

The main controller 30 has a storage section (e.g., RAM) for storing measured data required for controlling the injection locking, such as the detected results from the aforesaid respective monitors and data indicating a delay to be described later, a work area (e.g., RAM) for data processing by using the above data, and a storage section (e.g., ROM) for storing a program indicating a processing procedure to be described later, which are not shown in FIG. 4.

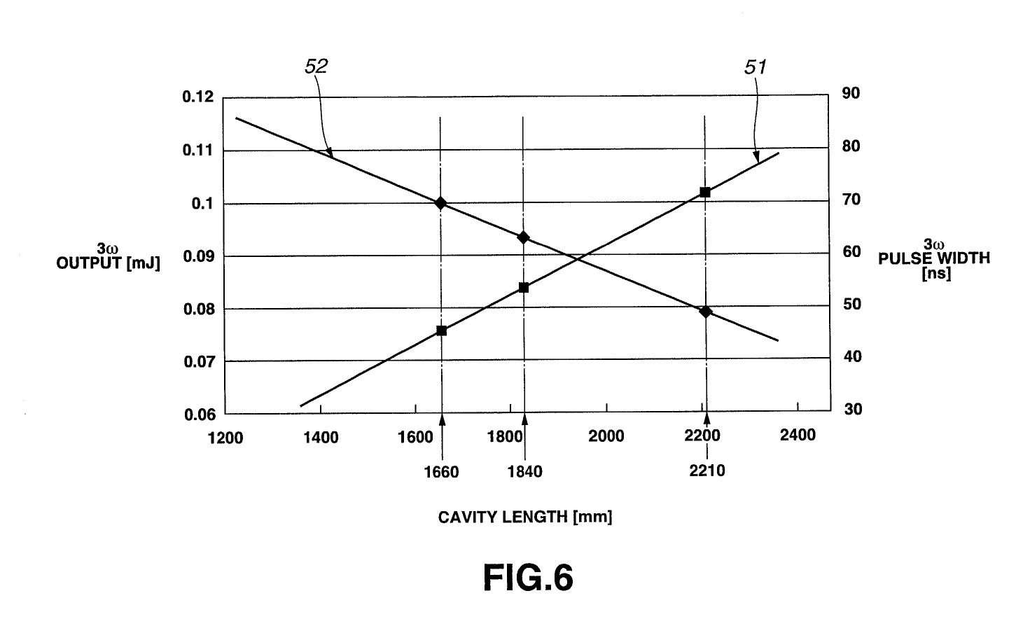

FIG. 6 shows a relation among a cavity length when the optical path length, namely the cavity length, between the rear mirror M1 and the front mirror M2 in the oscillator 10 is changed, output (light intensity) of the high harmonic light (laser light) output from the wavelength conversion section 45 and the pulse width of the high harmonic light.

In FIG. 6, example characteristics of the krypton fluorine (KrF) excimer laser are shown, and they are of the third high harmonic light having a wavelength of 248 nm which results from the wavelength conversion of the fundamental harmonic light having a wavelength of 745 nm.

According to characteristic 51 indicating a relation between the cavity length and the pulse width of the third high harmonic light, the cavity length and the pulse width of the third high harmonic light to be laser-oscillated are proportional to each other. According to characteristic 52 which indicates a relation between the cavity length and output (light intensity) of the third high harmonic light, the cavity length and output (light intensity) of the pulse laser (e.g., the third high harmonic light) to be laser-oscillated are inversely proportional to each other.

In other words, it is seen from the characteristics 51, 52 that the light intensity and pulse width of the third high harmonic light, namely the seed light La, are changed by changing the cavity length.

Then, the laser oscillation performed by the laser device 50 will be described with reference to FIG. 4.

It is assumed that the gas laser device 20 is a krypton fluorine (KrF) excimer laser device.

First, the main controller 30 sends a trigger signal to the pump laser 13 and the excimer power supply 25 so that timing of the laser oscillation of the oscillator 10 agrees with timing of the electrical discharge of the gas laser device 20.

In the oscillator 10, when the pump laser 13 oscillates the laser light (pumping light) according to the trigger signal, the pumping light is irradiated to the titanium sapphire 11.

The titanium sapphire 11 is thus pumped by the irradiated pumping light, and light (pumped light) is emitted from the titanium sapphire 11.

The pumped light travels to resonate between the rear mirror M1 and the front mirror M2 (in the optical resonator), and only light selected by the wavelength selection element 12 is emitted as the laser light (seed light) La from the front mirror M2.

Light (laser light) resonating in the optical resonator (between the rear mirror M1 and the front mirror M2) partly passes through the rear mirror M1, and the penetrated light (leakage light) is detected (monitored) by the wavelength monitor 16.

The wavelength monitor 16 sends a detection signal corresponding to the detected wavelength to the oscillation wavelength controller 17.

Based on the detection signal from the wavelength monitor 16, the oscillation wavelength controller 17 controls the wavelength selection element 12 or the mirror holder 14 so that the laser light having a desired wavelength is laser-oscillated.

Meanwhile, the laser light La emitted from the front mirror M2 is entered into the wavelength conversion section 45 via the reflection mirrors 41, 42.

The wavelength conversion section 45 makes the wavelength conversion of the incident laser light La, namely the fundamental harmonic light, into predetermined high harmonic light (third high harmonic light in this case) Lb and outputs it. The high harmonic light Lb is entered (injected) into the gas laser device 20 via the reflection mirrors 43, 44.

The high harmonic light Lb injected into the gas laser device 20 is entered into the laser chamber 21 through the laser inlet 23a of the concave mirror 23.

In the gas laser device 20, the gas laser power supply 25 receives the trigger signal from the main controller 30 and sends a high voltage pulse to the electrical discharge electrodes 22 after a lapse of predetermined time according to the introduction timing of the high harmonic light Lb. Thus, a uniform electrical discharge is caused between the electrical discharge electrodes 22 to which the high voltage pulse is applied.

When the laser medium is pumped by the electrical discharge caused by the electrical discharge electrodes 22 while the high harmonic light Lb is being injected, the high harmonic light Lb injected by the injection locking travels to resonate between the convex mirror 24 and the concave mirror 23 (optical resonator) so to be amplified and is output as the laser light Lc.

Meanwhile, the power monitor 47 detects output (light intensity) of light (leakage light), which has passed through the reflection mirror 43, in the high harmonic light Lb which has entered into the reflection mirror 43 from the wavelength conversion section 45, and sends the detected result (signal indicating the light intensity) to the main controller 30.

The pulse monitor 46 detects light (leakage light), which has passed through the reflection mirror 44, in the high harmonic light Lb having entered into the reflection mirror 44, and sends the detected result (signal indicating a pulse waveform) to the main controller 30.

The pulse monitor 26 detects luminescence (electrical discharge light) Ld resulting from the electrical discharge caused between the electrical discharge electrodes 22 and sends the detected result (signal indicating a pulse waveform) to the main controller 30.

The power monitor 48 detects output (light intensity) of the output laser light Lc reflected by the beam splitter B•S and outputs the detected result to the main controller 30.

The main controller 30 having received the detected results from the respective monitors adjusts the light intensity and pulse width of the laser light according to the detected results.

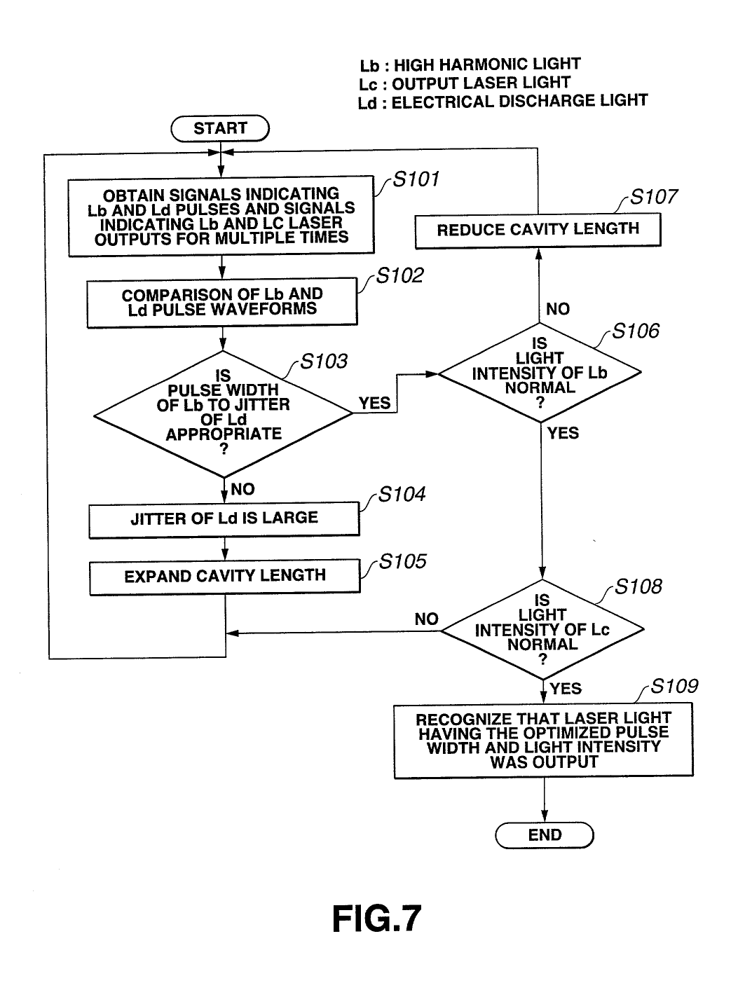

Processing by the main controller 30 to adjust the light intensity and pulse width of the laser light will be described with reference to FIG. 7 showing an adjusting procedure.

The main controller 30 obtains a signal indicating a waveform of the electrical discharge light Ld from the pulse monitor 26 and a signal indicating a waveform of the high harmonic light Lb from the pulse monitor 46 in plural numbers for different laser oscillations while the laser oscillation is repeatedly performed, and also obtains a signal indicating output (light intensity) of the high harmonic light Lb from the power monitor 47 and a signal indicating output (light intensity) of laser light Lc output from the power monitor 48 in plural numbers for different laser oscillations (step S101).

The respective signal data from the respective monitors are stored in an unshown storage section of the main controller 30.

The main controller 30 refers to data on the pulse waveforms stored in the storage section to compare the waveform of the electrical discharge light Ld and that of the high harmonic light Lb (step S102) and determines whether the pulse width of the high harmonic light Lb to the jitter of the electrical discharge light Ld is appropriate or not (step S103).

If the lead portion of the electrical discharge light Ld is included in a predetermined ratio into a total width of the electrical discharge light Ld while the high harmonic light Lb is being injected, it is determined that the pulse width of the high harmonic light Lb to the jitter of the electrical discharge light Ld is appropriate.

The main controller 30, which has determined in step S103 that the pulse width of the high harmonic light Lb to the jitter of the electrical discharge light Ld is not appropriate, judges that the jitter (time error) of the electrical discharge light Ld in the gas laser device 20 is large (step S104). And to extend the pulse width of the laser light (seed light) La oscillated by the oscillator 10, the main controller 30 controls to move the translating stage 15 by rotating the drive motor in a predetermined direction to extend the cavity length (step S105).

Then, the main controller 30 returns to step S101 to adjust the light intensity and pulse width of the laser light (seed light) at the next pulse laser oscillation.

What is described above is the adjusting procedure of the pulse width of the laser light (seed light) La to be laser-oscillated in the oscillating stage by the adjustment of the cavity length.

Then, an adjusting procedure of the light intensity of the laser light (seed light) La to be laser-oscillated in the oscillating stage by the adjustment of the cavity length will be described.

Specifically, the main controller 30, which has determined in step S103 that the pulse width of the high harmonic light Lb to the jitter of the electrical discharge light Ld is appropriate, refers to data on the light intensity stored in the storage section to determine whether the light intensity of the high harmonic light Lb has a value equal to or higher than predetermined threshold value Ith1 (whether the light intensity is normal or not) (step S106).

The main controller 30, which has determined that the light intensity of the high harmonic light Lb has a value smaller than the threshold value Ith1 and is not normal, judges that the light intensity of the output laser light Lc is also not normal because the injection locking is not effective, and in order to enhance the light intensity of the laser light (seed light), namely the fundamental harmonic light La, output from the oscillator 10, controls to move the translating stage 15 by rotating the drive motor in a predetermined direction to shorten the cavity length (step S107).

Then, the main controller 30 returns to step S101 to adjust the light intensity and pulse width of the laser light (seed light) at the next pulse laser oscillation.

The main controller 30, which has determined in step S106 that the light intensity of the high harmonic light Lb is normal, determines whether the light intensity of the output laser light Lc has a value equal to or higher than a predetermined threshold value Ith2 (whether the light intensity is normal or not) (step S108).

When it is determined in step S108 that the light intensity has a value smaller than the threshold value Ith2 and is not normal, it means that the judgment made in step S103 that the pulse width of the high harmonic light Lb to the jitter of the electrical discharge light Ld was appropriate was wrong.

For example, even when the electrical discharge light in a predetermined ratio in the electrical discharge light Ld is included during the injection period of the high harmonic light Lb, it is determined that the pulse width of the high harmonic light Lb to the jitter of the electrical discharge light Ld is appropriate but the judgment in step S103 was wrong for some causes.

When it is determined in step S108 that the light intensity has a value smaller than the threshold value Ith2 and is not normal, the procedure returns to step S101 to determine again whether the pulse width of the high harmonic light Lb to the jitter of the electrical discharge light Ld is appropriate or not.

Meanwhile, when it is determined in step S108 that the light intensity has a value equal to or higher than the threshold value Ith2 and is normal, it is recognized that the laser light (seed light) La having the optimized pulse width and light intensity was output in the oscillator 10 (step S109), and this processing is terminated.

At this time, it is needless to say that the output laser light Lc having a desired light intensity (a value equal to or higher than the threshold value Ith2) can be obtained.

Here, the threshold value Ith1 in step S106 is different from the threshold value Ith2 in step S108, the threshold value Ith1 is set to a value indicating the light intensity of the seed light at a level that the injection locking is performed in the gas laser device 20, and the threshold value Ith2 is set to a value indicating the light intensity required to perform predetermined processing (e.g., laser processing) by the output laser light Lc.

The reason of controlling the light intensity and pulse width of the laser light (seed light) La as described above is as follows.

Specifically, when the translating stage 15 is controlled to move (namely, to change the position of the rear mirror M1) so to expand or contract the optical resonator interval (namely, the cavity length) between the rear mirror M1 and the front mirror M2, a distance that the light emitted from the titanium sapphire 11 travels between them is changed. Thus, time required to take a laser gain is varied, resulting in changing the pulse width. But, because an absolute value of the laser gain does not change, when the pulse width of the seed light (corresponding to the third high harmonic light) is extended, the light intensity of the seed light is lowered accordingly as shown in FIG. 6.

Meanwhile, it is necessary to extend the pulse width of the laser light (seed light) La which is subjected to pulse laser oscillation by the oscillator 10 as the jitter of the electrical discharge light Ld in the gas laser device 20 as the amplifying stage becomes larger. It is also necessary to have a light intensity of a certain level (a value equal to or higher than the threshold value Ith2) so that the injection locking is applied in the gas laser device 20.

Therefore, it is necessary to obtain the laser light (seed light) La optimized by controlling the pulse width and light intensity, so that the processing procedure shown in FIG. 7 is performed in this embodiment to obtain the optimized laser light (seed light) La.

Besides, because the jitter of the electrical discharge light Ld may change depending on the electrical discharge conditions (an electrical discharge voltage, a chamber inside pressure, etc.) in the laser chamber 21, the processing procedure shown in FIG. 7 may be performed as required.

A time delay from the trigger signal sent to the gas laser power supply 25 to the electrical discharge by the electrical discharge electrodes 22 is gradually variable as the laser device 50 is repeatedly operated (laser oscillating operation) for a long period. It is necessary to control the electrical discharge timing by detecting the electrical discharge light Ld in order to keep the electrical discharge timing at a constant level because it is variable as the delay changes.

The delay is variable depending on degradation of the laser medium gas, degradation of the electrical discharge electrodes 22, or a change in temperature of the atmosphere in the gas laser device 20, and particularly a change in temperature of the atmosphere in the vicinity of the optical path (optical axis).

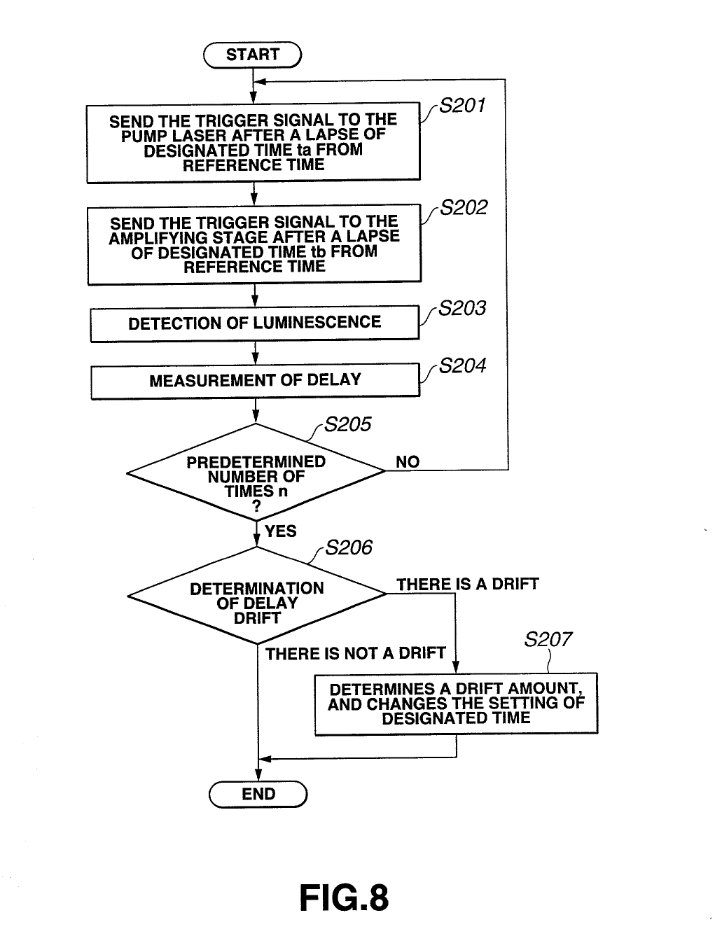

Then, a processing procedure to compensate the electrical discharge timing depending on the delay will be described with reference to FIG. 8 indicating the processing procedure.

After a lapse of designated time ta from a reference time with regard to the operation of one pulse of laser, the main controller 30 sends the trigger signal to the pump laser 13 (step S201), and after a lapse of designated time tb from a reference time with respect to the operation of one pulse of laser, sends the trigger signal to the gas laser power supply 25 of the gas laser device 20 as the amplifying stage (step S202).

Then, the oscillator 10 outputs the seed light (fundamental harmonic light) La on the basis of the trigger signal as described above. The fundamental harmonic light La is subject to the wavelength conversion by the wavelength conversion section 45 into the high harmonic light Lb and entered (injected) into the gas laser device 20.

Meanwhile, the gas laser device 20 pumps the laser medium by the electrical discharge caused by the electrical discharge electrodes 22 according to the trigger signal while the high harmonic light Lb is being injected as described above and output the laser light Lc according to the injection locking.

When the electrical discharge is caused by the electrical discharge electrodes 22, the pulse monitor 26 detects the luminescence (electrical discharge light) Ld produced by the electrical discharge (step S203), and the detected result is sent to the main controller 30.

The main controller 30 calculates a delay according to the detected result from the pulse monitor 26 (step S204).

Specifically, time (in other words, a delay) from the point of the rising edge of the trigger signal which was sent to the gas laser power supply 25 to the detected result from the pulse monitor 26, namely the predetermined point of the luminescence pulse is calculated.

Besides, the main controller 30 determines whether the steps S201 to S204 have been performed for a predetermined number of times n (step S205), and if not, returns to step S201. If they have been performed, the main controller 30 determines an average value of the delays for the number of times n calculated in step S204.

Data indicating the average delay (hereinafter called the delay data) is stored in an unshown storage section disposed in the main controller 30 every time step S205 is performed. Here, the delay data of the previous processing and the delay data of the present processing are stored in the storage section. In order to keep information on the changes in delay as record information, the previous delay data and earlier may also be stored.

And, the main controller 30 determines on the basis of the previous delay data and the present delay data stored in the storage section whether there is a delay drift or not (step S206). When it is determined that there is such a drift, the main controller 30 determines a difference between the previous delay and the present delay, namely a drift amount, and changes the setting of designated time to return to the original only by the determined drift amount (step S207).

This setting change of the designated time is performed when the next trigger signal is sent, to differ the sending timing (designated time ta or designated time tb) of the trigger signal to the gas laser power supply 25 or the pump laser 13 from the sending timing of the present trigger signal sent.

In the gas laser device 20, the delay may be shortened due to for example a change in ambient temperature around the optical path (optical axis). In order to keep the electrical discharge timing constant, the timing of sending the trigger signal to the gas laser power supply 25 may be delayed. For example, when a difference (drift amount) between the previous delay T1 and the current delay T2 (T1>T2) due to a change in ambient temperature is time T, the sending timing (designated time tb) of the next trigger signal to the gas laser power supply 25 is delayed by the time T.

By continuing the above processing during the laser oscillating operation, the electrical discharge timing is compensated depending on the delay, and stable output laser light Lc can be obtained.

In the aforesaid second embodiment, the gas laser device 20 as the amplifying stage uses a krypton fluorine (KrF) excimer laser (wavelength of 248 nm) as one of gas lasers, but it is not limitative, and excimer lasers such as an XeCl excimer laser (wavelength of 308 nm), an XeF excimer laser (wavelength of 353 nm) and an argon fluorine (ArF) excimer laser (wavelength of 193 nm), or a fluorine (F2) laser (wavelength of 157 nm) may be used.

In this case, it is necessary to make wavelength conversion of the fundamental harmonic light to be laser-oscillated in the oscillating stage by the wavelength conversion section 45 so to conform to the oscillation wavelength in the amplifying stage.

For example, when the fluorine (F2) laser is used in the amplifying stage, it is necessary to change in the wavelength conversion section 45 that one CLBO is added as a nonlinear optical element to the next stage of CLBO 45C of the configuration shown in FIG. 5, and the 4ω mirror 45D is changed to a 5ω mirror for reflecting only fifth high harmonic light (5ω).

The added new CLBO produces the fifth high harmonic light (5ω) by sum frequency mixing of the fundamental harmonic light and the fourth high harmonic light on the basis of the light output from the CLBO 45C and outputs the produced fifth high harmonic light, the remaining fundamental harmonic light and the second to fourth high harmonic lights. The 5ω mirror reflects only the fifth high harmonic light (5ω) in the light output from the new CLBO. Thus, when the fluorine (F2) laser is used, the laser light La (fundamental harmonic light) having a wavelength of 785 nm can be wavelength-converted into the laser light Lb which is the fifth high harmonic light.

In the aforesaid second embodiment, a nonlinear optical element such as CLBO or KTP (KTiOPO4) may be used instead of LBO and BBO used as the nonlinear optical element in the wavelength conversion section 45.

Besides, the second embodiment can also perform the application examples of (A) to (F) described in the first embodiment. When performing the application example (A)-(1), the main controller 30 is used instead of the resonator length adjusting controller 19 to rotate the drive motor in a predetermined direction to control the movement of the translating stage.

As described above, according to the second embodiment, for one of the laser models such as an F2 laser and excimer lasers (KrF, ArF, etc.), optimized seed light La can be obtained by controlling the pulse width and light intensity by expanding or contracting the cavity length of the oscillator 10 according to the processing procedure shown in FIG. 7 to meet the jitter (a time error at oscillation) and saturation intensity (laser intensity in the oscillating stage necessary for the injection locking) inherent in each device.

It means that for example even if the electrodes 22, the gas laser power supply 25 or the like is different in the gas laser device 20 as the amplifying stage, a desired laser characteristic can be obtained without changing the design of the oscillator 10 as the oscillating stage when the oscillation wavelength is the same (namely, the laser medium gas is the same).

Specifically, the laser characteristics (including jitter) of the gas laser device 20 are different when the electrodes 22 are different in size, space therebetween or shape or when the gas laser power supply 25 is different in charging method, pulse compression method or switching method, so that the gas laser device 20 has different laser characteristics (including jitter). But, this embodiment can obtain desired laser characteristics without changing the design of the oscillator 10 as the oscillating stage if the laser medium gas is the same (in other words, the oscillation wavelength is the same).

Therefore, after designing and manufacturing the laser device 50 having a particular jitter and a saturation intensity, the pulse width and light intensity of the seed light La is adjusted according to the aforesaid processing procedure shown in FIG. 7, and the pulse width and light intensity of the laser light to be injected into the gas laser device as the amplifying stage can be adjusted by changing the cavity length (optical resonator length) of the oscillator as the oscillating stage.

When the pulse width of the laser light to be pulse-oscillated is to be expanded by the prior art after determining the cavity length in the designing stage of the oscillator as the oscillating stage, it is necessary to redesign the laser device entirely.

[Third Embodiment]

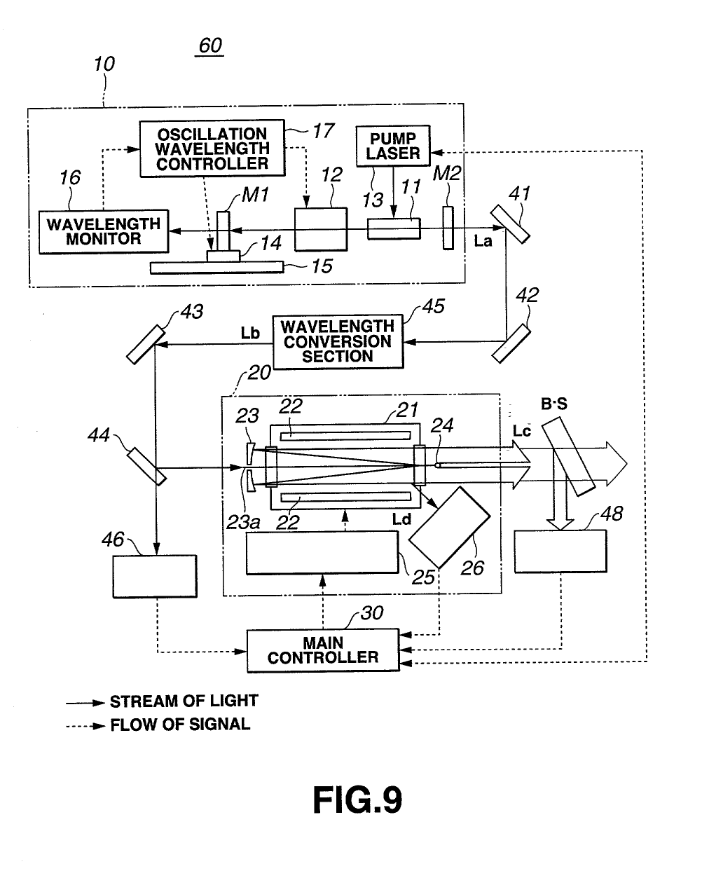

FIG. 9 is a structure diagram showing a structure of laser device 60 according to the third embodiment.

The laser device 60 has the same structure as the laser device 50 of the second embodiment shown in FIG. 4 except that the power monitor 47 is deleted. In FIG. 9, like reference numerals are used to indicate like components which have the same functions as those shown in FIG. 4.

In this embodiment, compensation processing of electrical discharge timing depending on a delay is the same as in the second embodiment.

But, in this embodiment, the processing of adjusting the pulse width and light intensity so to meet the jitter (a time error at oscillation) and saturation intensity (laser intensity in the oscillator stage necessary for the injection locking) inherent in each gas laser, for example an excimer laser device, cannot be controlled automatically by the main controller 30, so that the adjusting processing is performed by a person (operator) who adjusts the laser device.

Specifically, in order to adjust the pulse width and light intensity in the third embodiment, the optical length, namely the cavity length, between the rear mirror M1 and the front mirror M2 is adjusted by the following three methods.

A first method changes the cavity length by manually operating the switch for the drive motor for the translating stage 15 to change the position of the rear mirror M1.

A second method changes the cavity length by a linear guide disposed instead of the translating stage 15, which is manually moved to change the position of the rear mirror M1.

A third method changes the cavity length by the rear mirror M1 which is mounted on a particular mirror mount by disposing a plurality of mirror mounts on which a mirror can be mounted at any positions on the optical path instead of the translating stage 15. Besides, it is not necessary to dispose a plurality of mirror mounts by mounting a removable mirror mount at any position on the optical path, and the rear mirror M1 which is mounted on the mirror mount can be changed its position as required.

And, the third embodiment requires means for indicating the results of detecting the output laser light by the power monitor 48 and the electrical discharge light by the pulse monitors 26, 46. The indicating means may obtain signals for indication directly from the monitors 26, 46, 48 or via the main controller 30.

For example, when the operator refers to the contents indicated by the indicating means to find that the light intensity of the output laser light Lc has not reached a predetermined value, the laser device 60 is paused, and the translating stage 15 is moved to shorten the cavity length.

Besides, the third embodiment can also perform the application examples (A) to (F) described in the first embodiment. In the application example (A)-(1), the translating stage must be moved manually because of the structure.

As described above, according to the third embodiment, the cavity length is changed by the operator (worker) but the same action and effect as in the second embodiment can be expected.

What is claimed is:

1. A laser device which has an optical resonator, a laser medium disposed in the optical resonator and a pumping source for pumping the laser medium, and which resonates in the optical resonator the pumped light from the laser medium pumped by the pumping source to perform laser oscillation of laser light,
wherein the optical resonator is disposed to have an adjustable resonator length and, provided with:
detecting means for detecting the laser-oscillated laser light, and
adjusting means for adjusting the resonator length of the optical resonator on the basis of a result detected by the detecting means.

2. A laser device comprising:
an oscillating stage which has an optical resonator disposed to have an adjustable resonator length and outputs light resonated by the optical resonator as seed light;
an amplifying stage which has a laser medium and a pumping source, and outputs pulse light by stimulated emission of the seed light to amplify when pumping of the laser medium by the pumping source is synchronized with injection of the seed light output from the oscillating stage; and
detecting means for detecting the pulse light,
wherein the resonator length of the optical resonator is adjusted on the basis of a result detected by the detecting means.

3. A seed light optimizing method, comprising:
an oscillating step for outputting light resonated by an optical resonator, which is disposed to have an adjustable resonator length, as seed light;
an amplifying step for outputting pulse light by stimulated emission of the seed light to amplify when pumping of a laser medium by a pumping source for pumping the laser medium is synchronized with injection of the seed light output by the oscillating step;
a detecting step for detecting the pulse light; and
an adjusting step for adjusting the resonator length of the optical resonator on the basis of a result detected by the detecting step.
